(19) United States
(12) Patent Application Publication
(10) Pub. No.: US 2020/0249637 A1
(43) Pub. Date: Aug. 6, 2020

(54) ENSEMBLE CONTROL SYSTEM, ENSEMBLE CONTROL METHOD, AND ENSEMBLE CONTROL PROGRAM

(71) Applicant: NEC Corporation, Tokyo (JP)

(72) Inventors: Wemer WEE, Tokyo (JP); Riki ETO, Minato-ku (JP); Yoshio KAMEDA, Minato-ku (JP)

(73) Assignee: NEC Corporation, Tokyo (JP)

(21) Appl. No.: 16/639,821

(22) PCT Filed: Sep. 22, 2017
(86) PCT No.: PCT/JP2017/034316

§ 371 Date: Feb. 18, 2020

(51) Int. Cl. G05B 13/02; G06N 20/20

(52) U.S. Cl. CPC G05B 13/029; G06N 20/20

(57) ABSTRACT

An ensemble control system 80 combines different types of plant control. A plurality of subcontrollers 81 output actions for the plant control based on a prediction result by a predictor. A combiner or switch 82 combines or switches actions to maximize prediction or control performance as best control action based on the actions output by each subcontroller 81. Subcontrollers 81 include at least two types of subcontrollers. A first type subcontroller is an optimization-based subcontroller which optimizes an objective function that is a cost function to be minimized for calculating actions and outputs a control action. A second type subcontroller is a prediction-subcontroller which predicts based on machine learning models and outputs a predicted action.

### TECHNICAL FIELD

The present invention relates to an ensemble control system, an ensemble control method, and an ensemble control program for creating a data-driven controller that combines control theory methods with machine learning techniques for generating decision making policies.

### Background Art

The goal in control systems is to find optimal actions that are required for executing desired plans for completing a challenging task. How the actions are generated or computed depends significantly on the design and structure of the learning, planning or control method that is at the core of the system.

In many advanced industrial systems, model-based control techniques comprise a well-known and reliable approach to generating control actions that are optimal based on specific objective criteria and known system dynamics, see for example PLT 1. Model-based control design has become increasingly sophisticated and controllers based on this approach are able to perform complicated actions as better information about the system gets integrated in the design. Moreover, model-based control is theoretically well-founded. In many cases, their control properties have been established and can be analyzed using well-known techniques. Specifically, model predictive control (MPC) has emerged as a reliable tool in many advanced large-scale control systems, and under certain assumptions on the model and objective function, properties such as stability or feasibility can be guaranteed.

On the other hand, machine learning methods, especially deep learning approaches, have recently been gaining popularity as a tool for generating control inputs due to the availability of large amounts of different kinds of data. Deep neural networks have been used in successfully performing complicated human-level tasks, such as for self-driving cars in NPL 1. The popularity of the deep learning-based approach stems from its flexibility in the sense that no expert knowledge about the system to be controlled is necessary, and they have the capability of capturing nonlinear expert behavior quite well, making them applicable in a wide variety of cases.

PLT 2 discloses a system that controls operation by a controller. The system disclosed in PLT 2 includes a group of control modules that independently operate in parallel. The control module group includes a PID (Proportional-Integral-Differential) controller that adopts a PID as a control principle, an MRAC (Model Reference Adaptive Control) controller that performs model-based adaptive control based on a neural network, and an LQG (Linear-Quadratic-Gaussian) controller that adopts LQG as a control principle. Moreover the system selects and outputs a control variable whose prediction result is closest to the target value.

### CITATION LIST

### Patent Literature

PTL 1: U.S. Unexamined Patent Application Publication No. 2016/0091897 A1

PTL 2: Japanese Patent Application Laid-Open No. H10-003301

### Non-Patent Literature

NPL 1: End to End Learning for Self-Driving Cars, Bojarski et al., 2016.

### SUMMARY OF INVENTION

### Technical Problem

As computing hardware becomes better and more readily available, the intense computation required for implementing at least two approaches for control simultaneously or in parallel becomes more feasible.

In the model-based control approach, complicated objectives can be difficult to express explicitly or can have very complex representations, making them challenging to include in the computation of control actions. For example, as more complicated behavior or objectives are being considered in many industrial applications, a possible drawback is the computational expense, which is due to the nonlinearity involved in many challenging objectives. At the same time, for some qualitative concepts such as comfort in the autonomous driving context, formulating an objective function can usually be complex.

On the other hand, in the deep learning-based approach, although no expert model is required, training is expensive and the resulting model is not interpretable, making it difficult to check the reliability of the control actions especially in complex situations. Specifically, training is quite complicated and time consuming, and the resulting model is not directly accessible to interpretation. In safety-critical tasks such as autonomous driving, it is important to be able to understand and verify if such a learning-based controller will always perform as expected.

The principles underlying each control method design can vary significantly and might be conflicting to each other. As expected however, their fundamental differences in design afford each their own distinct advantages. It is thus desirable to design a controller in such a way that it is able to exploit the advantages of each approach and be able to calculate actions in a way that mimics or replicates the behavior of each component but at the same time also provide an entirely different way of generating control policies.

That is, it is thus desirable to be able to fuse the above approaches in a framework that is provably reliable and at the same time steadily improving in capturing many nonlinear objectives as more training data is used, in order to address the limitations inherent to each type and provide a more general type of control. However, PLT 2 does not disclose fusing multiple approaches.

The subject matter of the present invention is directed to realizing the above features in order to overcome, or at least reduce the effects of, one or more of the problems set forth above. That is, it is an exemplary object of the present invention to provide an ensemble control system, an ensemble control method and an ensemble control program capable of optimally combining the distinct advantages of different types of control approaches.

### Solution to Problem

An ensemble control system according to the present invention is an ensemble control system which combines different types of plant control, the ensemble control system includes: a plurality of subcontrollers each of which outputs action for the plant control based on a prediction result by a predictor; and a combiner or switch which combines or switches actions to maximize prediction or control performance as best control action based on the actions output by each subcontroller, wherein subcontrollers include at least two types of subcontrollers, a first type subcontroller is an optimization-based subcontroller which optimizes an objective function that is a cost function to be minimized for calculating actions and outputs a control action, and a second type subcontroller is a prediction-subcontroller which predicts based on machine learning models and outputs a predicted action.

An ensemble control method according to the present invention is an ensemble control method which combines different types of plant control, the ensemble control method includes: optimizing an objective function that is a cost function to be minimized for calculating actions and outputting a control action; predicting based on machine learning models and outputting a predicted action; and combining or switching actions to maximize prediction or control performance as best control action based on the output actions.

A ensemble control program according to the present invention is an ensemble control program mounted on a computer which combines different types of plant control, the program causing the computer to perform: an optimizing process of optimizing an objective function that is a cost function to be minimized for calculating actions and outputting a control action; a predicting process of predicting based on machine learning models and outputting a predicted action, and a combining or switching process of combining or switching actions to maximize prediction or control performance as best control action based on the output actions. Advantageous Effects of Invention

According to the present invention, it is possible to optimally combine the distinct advantages of different types of control approaches.

### BRIEF DESCRIPTION OF DRAWINGS

FIG. 1 It depicts a block diagram illustrating the structure of a first exemplary embodiment of an ensemble control system according to the present invention.

FIG. 2 It depicts an explanatory diagram illustrating the structure of a first exemplary embodiment of an ensemble control system according to the present invention.

FIG. 3 It depicts a flowchart illustrating an operation example of the ensemble control system.

FIG. 4 It depicts a block diagram illustrating the structure of a second exemplary embodiment of an ensemble control system according to the present invention.

FIG. 5 It depicts an explanatory diagram illustrating the structure of a second exemplary embodiment of an ensemble control system according to the present invention.

FIG. 6 It depicts a block diagram illustrating an overview of an ensemble control system according to the present invention.

### DESCRIPTION OF EMBODIMENTS

The following describes an exemplary embodiment of the present invention with reference to drawings. The present invention relates to a method and system for creating an ensemble of controllers for a more effective and generalized control that leverages the advantages of each type of control. The preferred and alternative embodiments, and other aspects of subject matter of the present disclosure will be best understood with reference to a detailed description of specific embodiments, which follows, when read in conjunction with the accompanying drawings.

The following discussion of the embodiments of the present disclosure directed to a method and system for creating an ensemble of controllers is merely exemplary in nature, and is in no way intended to limit the disclosure or its applications or uses.

### First Exemplary Embodiment

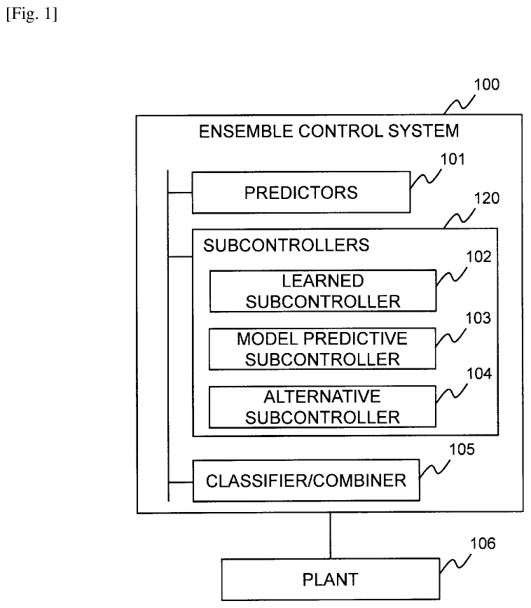

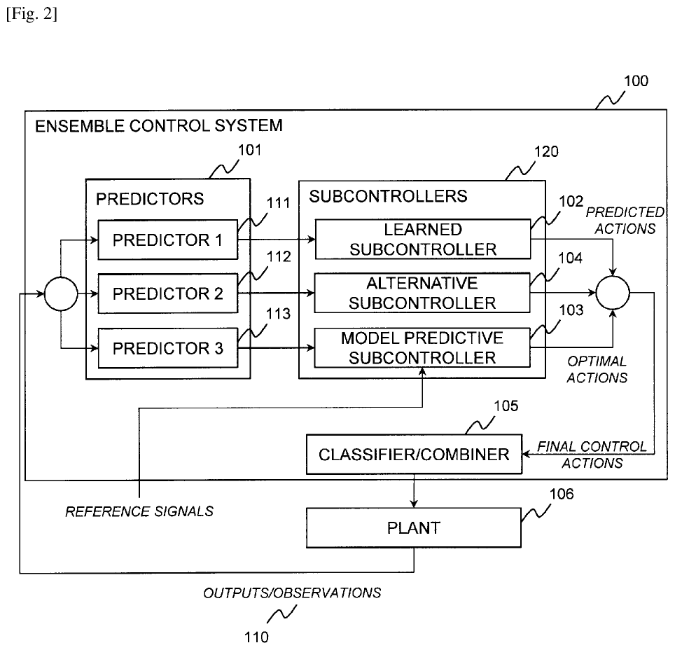

FIG. 1 is an exemplary block diagram illustrating the structure of a first exemplary embodiment of the ensemble control system according to the present invention. FIG. 2 is an exemplary explanatory diagram illustrating the structure of a first exemplary embodiment of the ensemble control system according to the present invention. The ensemble control system of the present embodiment combines different control approaches for plant control.

The ensemble control system 100 according to the present exemplary embodiment includes predictors 101, subcontrollers 120, and a classifier or combiner (hereinafter, classifier/combiner) 105. According to the present exemplary embodiment, the classifier/combiner 105 sends control actions for actuation in the plant 106. The plant 106 sends plant outputs 110 to the predictors 101. The plant outputs 110 are acquired by the sensor (not shown) of the plant 106. The plant 106 may acquire disturbances as part of the plant outputs 110.

The subcontrollers 120 may include any number of subcontrollers, which can be of any type. According to the present exemplary embodiment, three types of subcontrollers, that is, learned subcontrollers 102, model predictive subcontroller(s) 103, alternative subcontroller(s) 104 are assumed. The subcontrollers 120 may include all these types of subcontrollers, or may include some type of sub-controller. In the following description, when describing features or qualities common to each subcontroller, it is simply referred to as a “subcontroller”.

The predictors 101 are associated to each subcontroller, and given outputs or observations 110 from the plant 106, the predictors 101 calculate predictions which are sent to the subcontrollers. In the example shown in FIG. 2, the predictors 101 includes three predictors (predictor 111, predictor 112 and predictor 113). The outputs or observations 110 can be, for example, the state of the plant 106 or variables related to the environment which are acquired by the sensor.

The predictors 101 may employ any machine learning technique such as kernel methods or deep neural networks, and each predictor 101 computes state predictions that are required by each type of subcontroller. The predictors 101 can also be classifiers or detectors depending on the needs of the algorithms used in the subcontrollers.

For each of the subcontrollers, the outputs are the control actions required in the specific task, i.e., the control signals that are required by the actuator or a possibly fixed lower-level controller next to it, if present. In the case of autonomous driving for example, each of the subcontrollers will output their calculated “best” steering angle and acceleration, e.g., (0.785 rad, 2.5 m/sec\hat{ }2).

For the subcontrollers, the presence of different types such as learning-based and model predictive control-based controllers is ideal but not required. For example, the subcontrollers may include different model predictive controllers, without any learning-based controller, and vice versa. The contents of each assumed subcontroller will be described below.

The learned subcontroller 102 is trained using open-source or proprietary data, so that profiles of different plant operators can be captured. The learned subcontroller 102 can be based on deep reinforcement learning or other machine learning models. The models in the learned subcontroller 102 can be updated as soon as more data is collected from the plant or from a network of similar plants. The subcontrollers 120 may include a plurality of learned controllers 102.

As an example, for autonomous driving, the learned subcontrollers 102 can be deep neural networks, and several learned subcontrollers 102 can be constructed by using open-source data, data that are part of trade secrets of automakers, and data collected from an open or proprietary network of cars with the same built or model. A separate learned subcontroller 102 can also be trained which focuses on a specific driver of the car. In this way, the learned subcontroller 102 predicts based on predictive machine learning models. From the above, it can be said that the learned subcontrollers 102 is a prediction-subcontroller.

Note that there can be many learned subcontrollers 102 in the system, each of which might have been learned using different machine learning techniques, may be based on different predictive models, or trained using different datasets. For example, two learned subcontrollers 102 can both have the same model such as deep neural networks, but have been learned or tuned using different training data. Alternatively, it can be that using a single training dataset, one subcontroller is learned as a decision tree and one is a neural network.

The model predictive subcontroller 103 employs a plant model for state predictions and involves an objective function containing terms related to different criteria or performance indices, which is then optimized to compute for the control actions that are optimal in the sense of the performance indices in the model predictive subcontroller 103. From the above, it can be said that the model predictive subcontroller 103 is an optimization-based subcontroller.

Specifically, the model predictive subcontroller 103 optimizes an objective function that is a cost function to be minimized for calculating control actions. That is, the objective function to be optimized refers to the cost function that is minimized for calculating control actions in the model predictive subcontrollers 103. The objective function may be a weighted sum of terms that represent different performance measures, such as distance to target state or change in input. In the autonomous driving example, this is the sum of terms relating to distance to target location, change in acceleration and steering, comfort, or energy consumption.

Alternative subcontroller 104 can be any type of model-free or model-based technique from machine learning or control theory. Combinations of planning algorithms and control methods can also be considered in the alternative subcontroller 104.

By default, the control ensemble system 100 is considered to have at least two types of subcontrollers, and at least one subcontroller is required to be active at each time and the others may be inactive. Which subcontrollers are active or inactive depends on the task and the resulting choice of the ensemble method. Moreover, it is possible to have more than one subcontroller for each type of subcontroller (e.g., two active learned subcontrollers 102 and two active model predictive subcontrollers 103).

The subcontrollers receive predictions and observations from the predictors 101 and compute control actions depending on the underlying method or procedure in each system. All the calculated control actions are then collected in the classifier/combiner 105 for processing.

The classifier/combiner 105 then employs machine learning techniques, specifically ensemble methods, to determine the best control action based on the output control action by the subcontrollers. In other words, the classifier/combiner 105 determines the best control action as the final goal by selecting an appropriate subset of subcontrollers. The classifier/combiner 105 is connected to some, if not all, of the subcontrollers in the plurality of subcontrollers. As an example, the classifier/combiner 105 can use bagging or boosting techniques, and the type of ensemble technique can be chosen and built incrementally depending on the performance of each subcontroller in the training instances.

The classifier/combiner 105 may decide the best control operation to actuate by comparing the values of certain performance measures on which the input actions returned by the subcontrollers are evaluated, such as distance to surrounding objects, comfort level, safety and energy consumption, and choosing the action that minimizes a weighted sum of the said performance measures.

Also, similar to ensemble methods in machine learning, depending on the scenario and the nature of the control actions, the classifier/combiner 105 may also decide the best control operation from the outputs of the subcontrollers by voting, if for categorical actions, or by averaging, for numerical actions. The quality of resulting new actions from such approaches can also be evaluated using the performance measures described above and can be compared to the individual outputs of the subcontrollers if desired.

Moreover, the classifier/combiner 105 may keep the historical performance of each subcontroller in different kinds of control scenarios (such as driving maneuvers) assuming that the control actions obtained by each have been realized. This allows establishing confidence levels regarding the use of input actions from specific subcontrollers, and helps identification of poorly performing subcontrollers which might be removed or retrained.

As described above, the classifier/combiner 105 has the capability to merge the different control inputs (e.g., by averaging as mentioned above), and regarding just choosing the control actions between the different subcontrollers (e.g., by voting or using confidence levels). Therefore, the classifier/combiner 105 can be called “combiner or switch”. The classifier/combiner 105 then outputs the final control actions that are to be actuated in the plant 106.

The predictors 101, the subcontrollers 120 (more specifically, learned subcontrollers 102, model predictive subcontroller(s) 103, alternative subcontroller(s) 104), and the classifier/combiner 105 are each implemented by a CPU of a computer that operates in accordance with a program (ensemble control program). For example, the program may be stored in a storage unit (not shown) included in the ensemble control system, and the CPU may read the program and operate as the predictors 101, the subcontrollers 120 (more specifically, learned subcontrollers 102, model predictive subcontroller(s) 103, alternative subcontroller(s) 104), and the classifier/combiner 105 in accordance with the program.

In the ensemble control system of the present embodiment, the predictors 101, the subcontrollers 120 (more specifically, learned subcontrollers 102, model predictive subcontroller(s) 103, alternative subcontroller(s) 104), and the classifier/combiner 105 may each be implemented by dedicated hardware. Further, the ensemble control system according to the present invention may be configured with two or more physically separate devices which are connected in a wired or wireless manner.

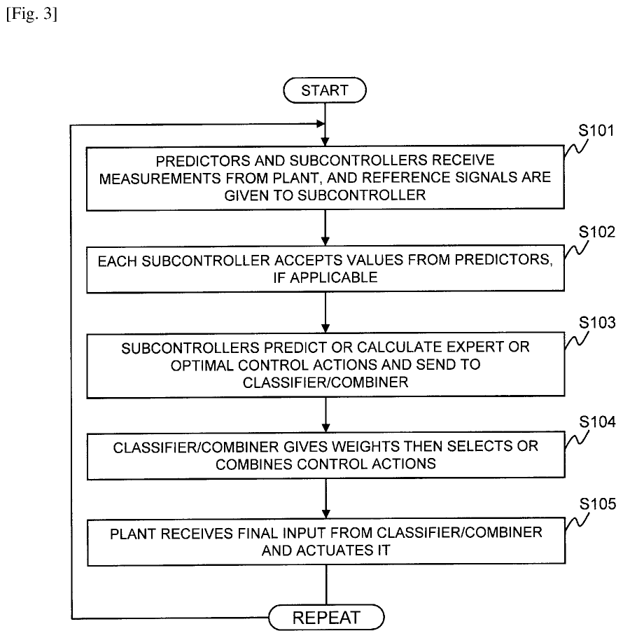

The following describes an example of the ensemble control system in this exemplary embodiment. FIG. 3 is a flowchart illustrating an operation example of the ensemble control system in this exemplary embodiment. For illustration purposes, consider a semi or fully automated driving scenario where the controlled variables are the front wheel steering angle and longitudinal speed.

First, at S101, the predictors 101 and subcontrollers receive state measurements such as position, speed and other observations from the plant 106 (e.g., vehicle). Reference signals such as destination, driving profile or comfort level are also sent to the subcontrollers as required. The operator may input preferences using a plant user interface.

At S102, the predictors 101 compute and transmit the necessary output predictions, such as forecasts of traffic participants' behaviors, that are required by the subcontrollers. That is, each subcontroller accepts values from predictors 101, if applicable.

At S103, the subcontrollers predict or calculate the expert or optimal control actions, that is, steering and acceleration, which are supposed to satisfy the objectives of each type of subcontroller. The subcontrollers then sends the control actions to the classifier/combiner 105.

At S104, the classifier/combiner 105 employs ensemble methods to combine the control actions that can maximize predictive or control performance, or the classifier/combiner 105 uses weights for selecting the appropriate final control action based on the historical performance of the subcontrollers, e.g., closeness to obstacles, fuel consumption, effects on passengers, etc.

At S105, the classifier/combiner 105 sends the plant 106 the final steering and acceleration control action for actuation. The plant 106 receives final input from classifier/combiner 105 and actuates it.

In this manner, in the present exemplary embodiment, each of the subcontrollers outputs action for the plant control based on a prediction result by predictors 101; and the classifier/combiner 105 combines or switches actions to maximize prediction or control performance as best control action based on the actions output by each subcontroller. Furthermore, subcontrollers include at least two types of subcontrollers, the model predictive subcontroller 103 and the learned subcontroller 102 (hereinafter first type subcontroller and second type subcontroller). The first type subcontroller is an optimization-based subcontroller which optimizes an objective function that is a cost function to be minimized for calculating actions and outputs a control action. The second type subcontroller is a prediction-subcontroller which predicts based on machine learning models and outputs a predicted action.

With the above structure, it is possible to optimally combine the distinct advantages of different types of control approaches, e.g., model-based or model-free control theory and machine learning-based controllers, and avoiding the limitations of each, while providing a richer set of control policies that are not available to a single type of controller. That is, according to the present invention, control inputs with maximized performance based on a combination of subcontrollers can be calculated and richer and diverse control strategies can be realized and applied to the plant.

In other words, control inputs computed from an ensemble of different types of controllers can inherit the advantages of each component controller, specifically, the framework will be flexible for realizing complicated human-level tasks, maintaining a certain degree of interpretability, and accessibility to some level of safety and reliability guarantees.

To illustrate more clearly, consider the case of automated driving, in which model predictive subcontrollers 103 are being used for different autonomous driving tasks. For complicated maneuvers, the constraints or behaviors are difficult to quantify or are highly nonlinear which discourages their use in practice.

Such highly nonlinear behavior might be captured more easily using a more data-driven approach but current methods based on deep learning are less accessible to interpretation and have almost no guarantees of reliability.

The proposed solution is to build different types of controllers which are suitable to different kinds of tasks by employing all known public and private information from the car manufacturers. The collected data from the controlled car and other cars can also be used for training and updating the learning-based and model-based controllers.

The classifier/combiner 105 can then be chosen so as to maximize the predictive and/or control performance of the subcontrollers based on different performance criteria such as obstacle avoidance, fuel consumption and comfort level. The final control action can be obtained using ensemble methods or using weights based on the relative importance that can be related to past performance.

More specifically, some subcontrollers are basically realized based on prediction algorithms, which can be treated in a control context. One exemplary feature of the present invention is that control ensemble system 100 can alternately treat prediction algorithms as control techniques, and vice versa, thereby allowing us to apply both control-theoretic and learning approaches for handling outputs of each type. One exemplary advantage of the present invention is that it allows us to integrate one or several data-driven techniques that can be difficult to analyze or interpret with a principled control-theoretic approach, which may include guarantees of desirable control properties for practical industrial systems.

### Second Exemplary Embodiment

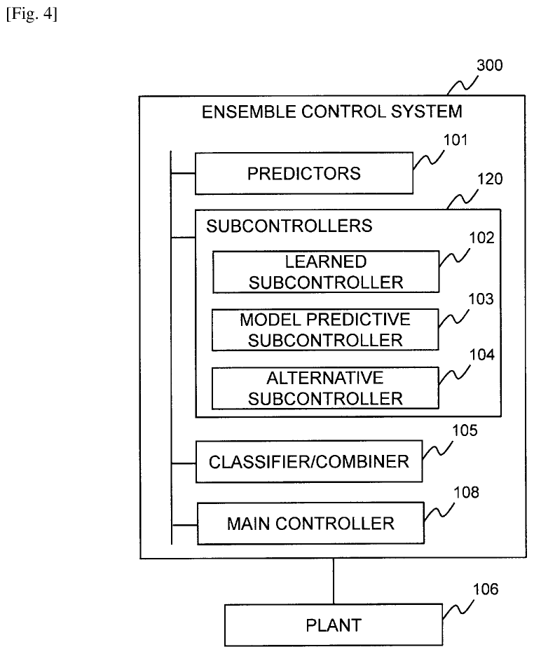

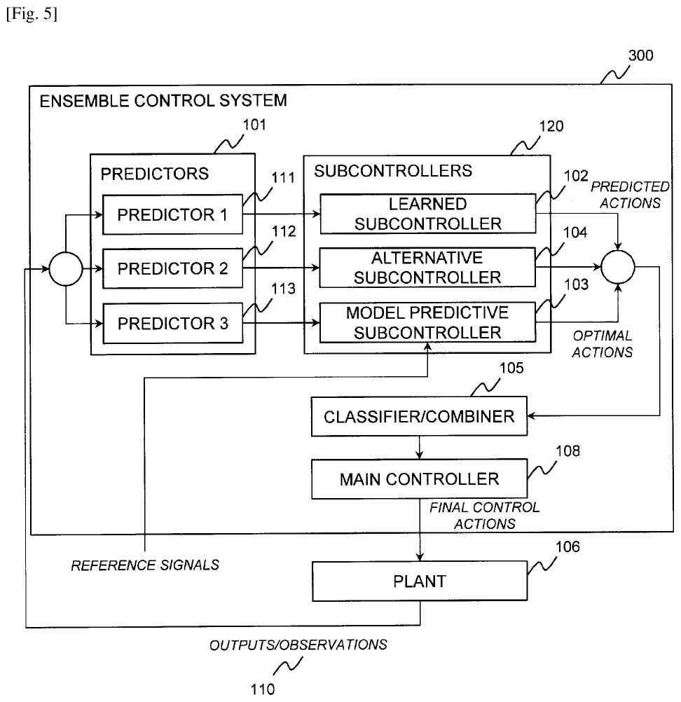

Next, a second embodiment of the ensemble control system according to the present invention will be described. FIG. 4 is an exemplary block diagram illustrating the structure of a second exemplary embodiment of the ensemble control system according to the present invention. FIG. 5 is an exemplary explanatory diagram illustrating the structure of a second exemplary embodiment of the ensemble control system according to the present invention.

The ensemble control system 300 according to the present exemplary embodiment includes predictors 101, subcontrollers 120 (e.g., learned subcontrollers 102, model predictive subcontroller(s) 103, and/or alternative subcontroller(s) 104), a classifier/combiner 105, and a main controller 108. That is, in addition to the ensemble control system of the first embodiment, the ensemble control system of this embodiment further includes the main controller 108. The rest of the configuration is the same as in the first embodiment.

A main controller 108 is considered as part of the control ensemble system 100 for additional guarantees based on the plant dynamics and constraints. The control action computed by the classifier/combiner 105 can be used as input to the main controller 108, which can be a model-based predictive controller. Compared to a possible use of model predictive controller as subcontroller 103, the main difference in using a model predictive controller as the main controller 108 is to assure that the final control actions satisfy all constraints and at the same time be close to the output of the classifier/combiner 105. Note that for computational purposes it is possible to consider only input tracking terms in which the control actions from the classifier/combiner 105 will be used. The main controller 108 then controls the plant 106 by using the control input with the minimum distance from the output of the classifier/combiner 105.

Specifically, the output of the classifier/combiner 105 that is sent to the main controller 108 are the control actions required by the actuator to perform the task, e.g., steering angle and acceleration in autonomous driving. The main controller 108 calculates the final control actions to be actuated by performing optimization with respect to plant dynamics and constraints. In the autonomous driving example, the main controller 108 may be a model predictive controller which solves an optimization problem for finding the steering angle and acceleration closest to the values sent by the classifier/combiner 105, subject to vehicle dynamics and constraints. The (steering and acceleration) values computed by the main controller 108 are the actual control actions that will be actuated in the plant 106.

With the above configuration, it is possible to obtain a richer and diverse set from which to get an expert control policy while guaranteeing satisfaction of dynamics and constraints of the plant 106.

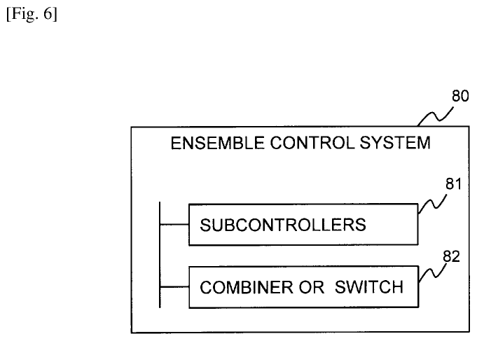

Next, an overview of the present invention will be described. FIG. 6 depicts a block diagram illustrating an overview of an ensemble control system of the present invention. An ensemble control system 80 (for example ensemble control system 100) according to the present invention is an ensemble control system which combines different types of plant control, the ensemble control system comprising: a plurality of subcontrollers 81 (for example learned subcontrollers 102, model predictive subcontroller(s) 103, alternative subcontroller(s) 104) each of which outputs action (for example control action, predicted action) for the plant control based on a prediction result by a predictor (for example predictors 101); and a combiner or switch 82 (for example classifier/combiner 105) which combines or switches actions to maximize prediction or control performance as best control action based on the actions output by each subcontroller 81, wherein subcontrollers 81 include at least two types of subcontrollers, a first type subcontroller is an optimization-based subcontroller (for example model predictive subcontroller 103) which optimizes an objective function that is a cost function to be minimized for calculating actions and outputs a control action, and a second type subcontroller (for example learned subcontroller 102) is a prediction-subcontroller which predicts based on machine learning models and outputs a predicted action.

With the above structure, it is possible to optimally combine the distinct advantages of different types of control approaches, and it is possible to inherit advantages of different types of control approaches, such as realizing highly complex tasks, maintaining certain levels of interpretability and having desirable control-theoretic properties.

Moreover, none of the objective functions in the plurality of the first type subcontrollers may be exactly the same.

Moreover, the first type subcontroller may use one or more state and control constraints to optimize an objective function, and at least two second type subcontrollers may predict based on different machine learning models.

Moreover, the combiner or switch 82 may compute a best control action to be actuated from the set of the control actions and the predicted actions output by the different subcontrollers 81.

Moreover, the ensemble control system 80 may include a main controller (for example main controller 108) which computes a best control action to be actuated from the set of the control actions and the predicted actions output by the different subcontrollers 81 by using plant dynamics and constraints.

Specifically, the combiner or switch 82 may compute a best control action and the main controller may calculate a final best action to be actuated by using plant dynamics and constraints.

The foregoing description of preferred and alternative embodiments is not intended to limit or restrict the scope or applicability of the inventive concepts of the present disclosure. One skilled in the art will readily recognize from such discussion and from the accompanying drawings and claims that various changes, modifications and variations can be made therein without departing from the spirit and scope of the disclosure as defined in the following claims.

### REFERENCE SIGNS LIST

100, 300 Ensemble control system

101 Predictors

102 Learned subcontroller

103 Model predictive subcontroller

104 Alternative subcontroller

105 Classifier/combiner

106 Plant

108 Main controller

110 Outputs

111, 112, 113 Predictor

120 Subcontrollers

1. An ensemble control system which combines different types of plant control, the ensemble control system comprising:
a plurality of subcontrollers, implemented by a hardware processor, each of which outputs action for the plant control based on a prediction result by a predictor; and
a combiner or switch, implemented by the hardware processor, which combines or switches actions to maximize prediction or control performance as best control action based on the actions output by each subcontroller,
wherein subcontrollers include at least two types of subcontrollers,
a first type subcontroller is an optimization-based subcontroller which optimizes an objective function that is a cost function to be minimized for calculating actions and outputs a control action, and
a second type subcontroller is a prediction-subcontroller which predicts based on machine learning models and outputs a predicted action.

2. The ensemble control system according to claim 1,
wherein none of the objective functions in the plurality of the first type subcontrollers are exactly the same.

3. The ensemble control system according to claim 1,
wherein the first type subcontroller uses one or more state and control constraints to optimize an objective function, and
wherein at least two second type subcontrollers predict based on different machine learning models.

4. The ensemble control system according to claim 1, wherein
the combiner or switch computes a best control action to be actuated from the set of the control actions and the predicted actions output by the different subcontrollers.

5. The ensemble control system according to claim 1, further comprising:
a main controller, implemented by the hardware processor, which computes a best control action to be actuated from the set of the control actions and the predicted actions output by the different subcontrollers by using plant dynamics and constraints.

6. The ensemble control system according to claim 5, wherein
the combiner or switch computes a best control action and
the main controller calculates a final best action to be actuated by using plant dynamics and constraints.

7. An ensemble control method which combines different types of plant control, the ensemble control method comprising:
optimizing an objective function that is a cost function to be minimized for calculating actions and outputting a control action;
predicting based on machine learning models and outputting a predicted action; and
combining or switching actions to maximize prediction or control performance as best control action based on the output actions.

8. The ensemble control method according to claim 7,
wherein none of the objective functions are exactly the same.

9. A non-transitory computer readable information recording medium storing an ensemble control program mounted on a computer which combines different types of plant control, when executed by a processor, the program performs a method for:
optimizing an objective function that is a cost function to be minimized for calculating actions and outputting a control action;
predicting based on machine learning models and outputting a predicted action, and
combining or switching actions to maximize prediction or control performance as best control action based on the output actions.

10. The non-transitory computer readable information recording medium according to claim 9,
wherein none of the objective functions are exactly the same.
